(19) United States
(12) Patent Application Publication
(10) Pub. No.: US 2015/0207575 A1
(43) Pub. Date: Jul. 23, 2015

(54) APPARATUS AND METHOD FOR TESTING ELECTRONIC DEVICE, AND NOISE BLOCKING MODULE THEREFOR

(71) Applicant: Avago Technologies General IP (Singapore) Pte. Ltd., Singapore (SG)

(72) Inventors: Jin Jeong, Kyunggi province (KR); Chris Chung, Seoul (KR)

(73) Assignee: Avago Technologies General IP (Singapore) Pte. Ltd., Singapore (SG)

(21) Appl. No.: 14/159,500

(22) Filed: Jan. 21, 2014

(51) Int. Cl. H04B 17/00

(52) U.S. Cl. CPC H04B 17/0085

(57) ABSTRACT

An apparatus for testing an electronic device in response to a radio frequency (RF) input signal includes an RF input signal generation source, a noise blocking unit, an RF signal transmission medium, a passband measurement unit, and a control unit. The RF input signal generation source generates the RF input signal. The noise blocking unit has a passband for passing the RF input signal and blocking noise to provide a noise blocked RF input signal. The RF signal transmission medium transmits the noise blocked RF input signal to the electronic device. The passband measurement unit measures the passband of the noise blocking unit based on the noise blocked RF input signal and outputs a passband value. The control unit performs feedback control of the passband by varying a control signal output to the noise blocking unit based on the passband value, so that the passband falls within a target range.

### BACKGROUND

Embodiments of the present invention relate to an apparatus and method for testing an electronic device that processes a radio frequency (RF) signal, and a noise blocking module for use therein, which are capable of ensuring accuracy of test results even in an environment crowded with noise, including RF signals.

In the field of electronic manufacturing industry, it is common to test electronic devices after they are manufactured. For instance, an RF power amplifier, which is well-known as an electronic device designed and manufactured for processing an RF signal, usually goes through testing. Results of the testing are used to sort out defective products.

In this regard, various types of test apparatuses have been implemented for the purpose of testing electronic devices. FIG. 12 is a block diagram schematically illustrating a partial configuration of an example of a conventional test apparatus. For example, the test apparatus 100 illustrated in FIG. 12 may be used to test a (multiband) power amplifier, indicated as device under test (DUT) D, which is capable of processing RF input signals RFᵢₙ₀, RFᵢₙ₁, . . . , RF_{inN-1} having respective bandwidths distinct from one another. The DUT D is mounted on a test unit 104 implemented with a test jig and a handler machine, for example. The RF input signals RFᵢₙ₀, RFᵢₙ₁, . . . , RF_{inN-1} from an RF input signal generation source 101 are transmitted to the DUT D via an RF signal transmission medium 102, which may be implemented with RF cables and accessories such as connectors, adapters, switches, and the like. The DUT D receives and amplifies the RF input signals RFᵢₙ₀, RFᵢₙ₁, . . . , RF_{inN-1}, and outputs amplified RF output signals RFₒᵤₜ₀, RFₒᵤₜ₁, . . . , RF_{outN-1}. The test unit 104 then determines that the DUT D is non-defective when the amplified RF signals RFₒᵤₜ₀, RFₒᵤₜ₁, . . . , RF_{outN-1} satisfy predetermined criteria for evaluating the performance of DUTs, and determines that the DUT D is defective otherwise.

Normally, electronic devices are tested in the same environment in which are manufactured. Accordingly, certain deleterious effects (hereinafter referred to as “noise”), such as heat, vibration, high frequency wave, moisture, etc., may be generated or otherwise abound in manufacturing facilities densely located in this environment. The noise may interfere with or adversely affect test results.

The test apparatuses, such as the test apparatus 100, operating in the manufacturing environment are therefore vulnerable to such noise. Even when the test apparatuses are designed to be noise-robust, there may be defects that occur upon implementation. Moreover, even when there is no problem with the design and the implementation of the test apparatuses, physical damage or wear may occur due to carelessness of a user or long-term usage, which may influence the performance of the test apparatuses, or portions thereof, such as the RF input signal generation source 101 and/or the RF signal transmission medium 102a of the test apparatus 100.

When noise propagates in a test apparatus, it may exert undesirable influences on the RF input signals, including a variety of types of distortion and signal phase-related errors attributable to the distortion, for example. These may, in turn, deteriorate accuracy and reliability of the test results.

In view of the aforementioned problems, efforts have been made to reduce the influence of noise on test apparatuses. One such effort includes a noise blocking unit, such as noise blocking unit 103 illustrated in FIG. 12, for example, which is interposed between the RF input signal generation source 101 and the test unit 104 to block undesirable radio waves using a filter or the like. Ideally, the noise blocking unit 103 receives RF input signals RFᵢₙ₀, RFᵢₙ₁, . . . , RF_{inN-1}, which may be accompanied by noise, and passes only components RFᵢₙ₀, RFᵢₙ₁, . . . , RF_{inN-1} that are within a predetermined frequency bandwidth (that is, a passband). Consequently, the RF input signals RFᵢₙ₀, RFᵢₙ₁, . . . , RF_{inN-1} can be protected from accompanying noise.

However, even when the noise blocking unit 103 is provided, the passband of the noise blocking unit 103 may shift due to certain factors that originate from the environment surrounding the test apparatus. Such a shift in passband may result in malfunctioning of the noise blocking unit 103. More specifically, the noise blocking unit 103 is usually implemented with an inductor and/or a capacitor. These components are related to an imaginary part in defining impedance of the noise blocking unit 103, and the corresponding electrical characteristics may vary with the phase of the RF signal that flows therethrough. Accordingly, when the phase of the RF input signal that is to be received by the noise blocking unit 103 is shifted for some reason, e.g., due to a defect in impedance matching network(s) provided inside or outside the noise blocking unit 103 or vulnerable points among low-quality RF cable and accessories constituting the RF signal transmission medium 102, the passband of the overall noise blocking unit 103 may be shifted.

The shift of the passband of the noise blocking unit 103 may also influence test results. For example, as illustrated in FIG. 13, a noise blocking unit 103 with a shifted passband may block component L of an RF signal that occurs outside the shifted passband (but would otherwise occur inside the preset passband), which means power loss in the RF signal. When the RF signal with lower power is input to the DUT D, a corresponding signal output from the DUT D may differ from what is expected. For instance, when the DUT D is an RF power amplifier, the amplified signal may have an insufficient power level, even though the DUT D is actually a non-defective product. Accordingly, the DUT D may be erroneously regarded as a defective product based on the shifted passband of the noise blocking unit 103.

Moreover, the shifted passband of the noise blocking unit 103 may reduce yield rate of DUTs. For instance, FIG. 14 illustrates results of simulating variations in yield rate while shifting the passband of the noise blocking unit 103. As shown in FIG. 14, signal-to-noise ratio is not significantly influenced and the yield rate is maintained at or above 90% when the shift in the passband is less than 25 MHz. In contrast, when the shift in the passband is higher than 30 MHz, for example, not only the signal-to-noise ratio but also the yield rate may be significantly reduced.

In addition, the above-described problems may become more pronounced when the DUT D is a multiband power amplifier. Since a test apparatus for testing the multiband power amplifier normally has a more complicated structure and a larger number of components than a test apparatus for testing a single-band RF power amplifier, the test apparatus for testing the multiband power amplifier may be more vulnerable and sensitive to noise.

Therefore, an improved test apparatus and method is needed for testing electronic devices, including a noise blocking module, which are capable of ensuring greater accuracy of test results, even in environments including noise along with the RF signals.

### BRIEF DESCRIPTION OF DRAWINGS

The features of embodiments of the present invention will become apparent from the following description in conjunction with the accompanying drawings, in which:

FIG. 1 is a block diagram illustrating configuration of an apparatus for testing an electronic device, in accordance with a representative embodiment;

FIG. 2 is a perspective view of a noise blocking device, in accordance with a representative embodiment;

FIG. 3 is a top plan view illustrating internal configuration of the noise blocking device, in accordance with a representative embodiment;

FIG. 4 is a bottom plan view illustrating internal configuration of the noise blocking device, in accordance with a representative embodiment;

FIG. 5 is a plan view of a noise filter implemented using a microstrip structure, in accordance with a representative embodiment;

FIG. 6 is a circuit diagram illustrating an equivalent electrical circuit of the noise filter of FIG. 5, in accordance with a representative embodiment;

FIG. 7 depicts variations in passband of a noise filter attributable to variations in a voltage value of a control signal input to the noise filter, in accordance with a representative embodiment;

FIG. 8 is a flowchart illustrating operation of a test apparatus for testing performance of DUTs, in accordance with a representative embodiment;

FIGS. 9 and 10 are flowcharts illustrating detailed steps of the method illustrated in FIG. 8 in accordance with a representative embodiment;

FIG. 11 is a graph illustrating variations in shifts in passband of the noise blocking unit and yield rate of DUTs attributable to use of the apparatus and method for testing the DUTs, in accordance with a representative embodiment;

FIG. 12 is a block diagram schematically illustrating a partial configuration of an example of a conventional apparatus for testing the RF power amplifier;

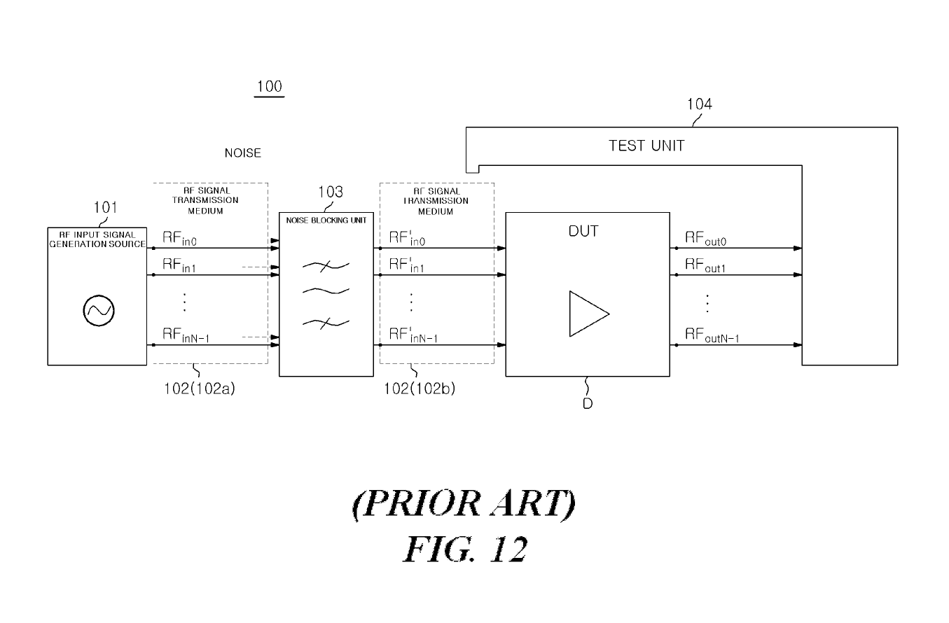

FIG. 13 is a graph illustrating the relationship between shifts in passband of the noise blocking unit of a conventional apparatus for testing the RF power amplifier and loss of power; and

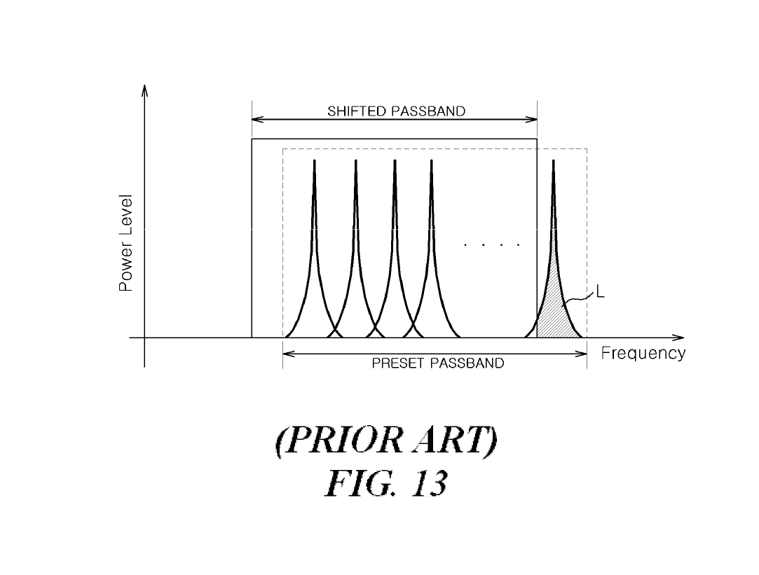

FIG. 14 is a graph illustrating variations in the signal-to-noise ratio of an RF input signal and the yield rate of RF power amplifiers attributable to shifts in passband of the noise blocking unit of the conventional apparatus for testing the performance of RF power amplifiers.

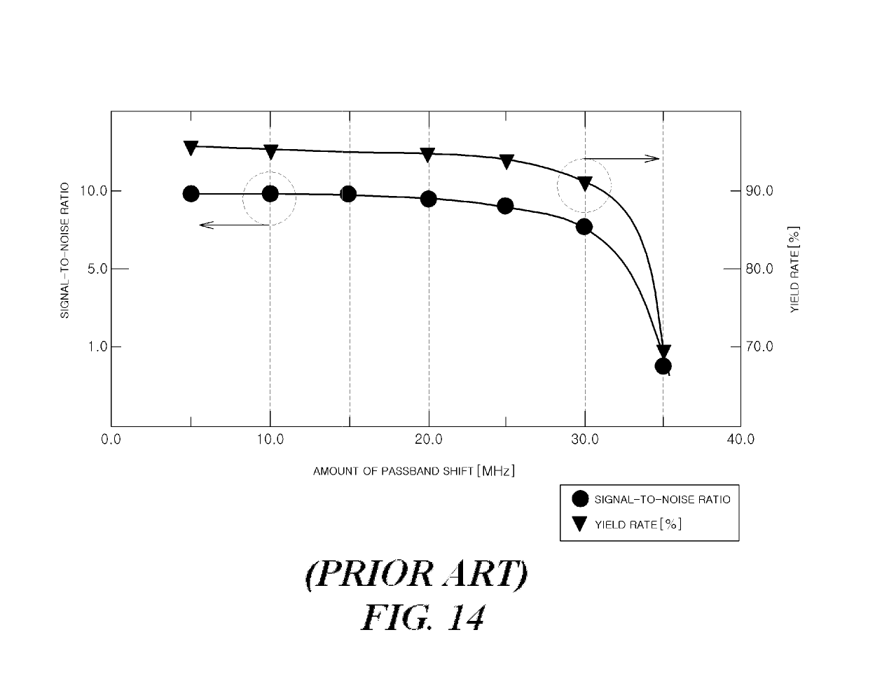

### DETAILED DESCRIPTION

Hereinafter, embodiments will be described in detail with reference to the accompanying drawings, in which like reference numerals refer to like elements, so that they can be readily implemented by one of ordinary skill in the art.

In the following detailed description, for purposes of explanation and not limitation, example embodiments disclosing specific details are set forth in order to provide a thorough understanding of the present teachings. However, it will be apparent to one having ordinary skill in the art having the benefit of the present disclosure that other embodiments according to the present teachings that depart from the specific details disclosed herein remain within the scope of the appended claims. Moreover, descriptions of known apparatuses and methods may be omitted so as to avoid obscuring the description of the example embodiments. Such methods and apparatuses are clearly within the scope of the present teachings.

The terminology used herein is for purposes of describing particular embodiments, and is not intended to be limiting. The defined terms are in addition to the technical, scientific, or ordinary meanings of the defined terms as commonly understood and accepted in relevant context.

The terms “a”, “an” and “the” include both singular and plural referents, unless the context clearly dictates otherwise. Thus, for example, “a device” includes one device and plural devices. The terms “substantial” or “substantially” mean to within acceptable limits or degree. The terms “about” and “approximately” mean to within an acceptable limit or amount to one of ordinary skill in the art. Relative terms, such as “above,” “below,” “top,” “bottom,” “upper” and “lower” may be used to describe the various elements' relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, for example, would now be below that element. Where a first device is said to be connected or coupled to a second device, this encompasses examples where one or more intermediate devices may be employed to connect the two devices to each other. In contrast, where a first device is said to be directly connected or directly coupled to a second device, this encompasses examples where the two devices are connected together without any intervening devices other than electrical connectors (e.g., wires, bonding materials, etc.).

In accordance with one aspect of the present invention, there is provided an apparatus for testing an electronic device in response to a radio frequency (RF) input signal includes an RF input signal generation source, a noise blocking unit, an RF signal transmission medium, a passband measurement unit, and a control unit. The RF input signal generation source is configured to generate the RF input signal. The noise blocking unit has a passband for passing the RF input signal and blocks noise to provide a noise blocked RF input signal. The RF signal transmission medium transmits the noise blocked RF input signal to the electronic device. The passband measurement unit is configured to measure the passband of the noise blocking unit based on the noise blocked RF input signal and output a passband value. The control unit is configured to perform feedback control of the passband by varying a control signal output to the noise blocking unit based on the passband value, so that the passband falls within a target range.

In accordance with another aspect of the present invention, there is provided a noise blocking module including a noise blocking unit, an RF signal transmission medium, a passband measurement unit, and a control unit. The noise blocking unit has a passband for passing an RF signal and blocking noise. The RF signal transmission medium transmits the RF signal via the noise blocking unit. The passband measurement unit is configured to measure the passband and output a passband value. The control unit is configured to perform a feedback control of the passband by varying a control signal provided to the noise blocking unit based on the passband value, so that the passband falls within a target range.

In accordance with still another aspect of the present invention, there is provided a method for testing an electronic device configured to process an RF signal. The method includes passing the RF signal and blocking noise with a passband of a noise blocking device; measuring the passband to obtain a passband value; performing feedback control of the passband by varying a control signal provided to the noise blocking device based on the passband value, so that the passband falls within a target range; transmitting the RF signal to the electronic device through the noise blocking device having the passband that falls within the target range; and analyzing an output from the electric device. The feedback control of the passband is performed using a control device having a processor and a memory.

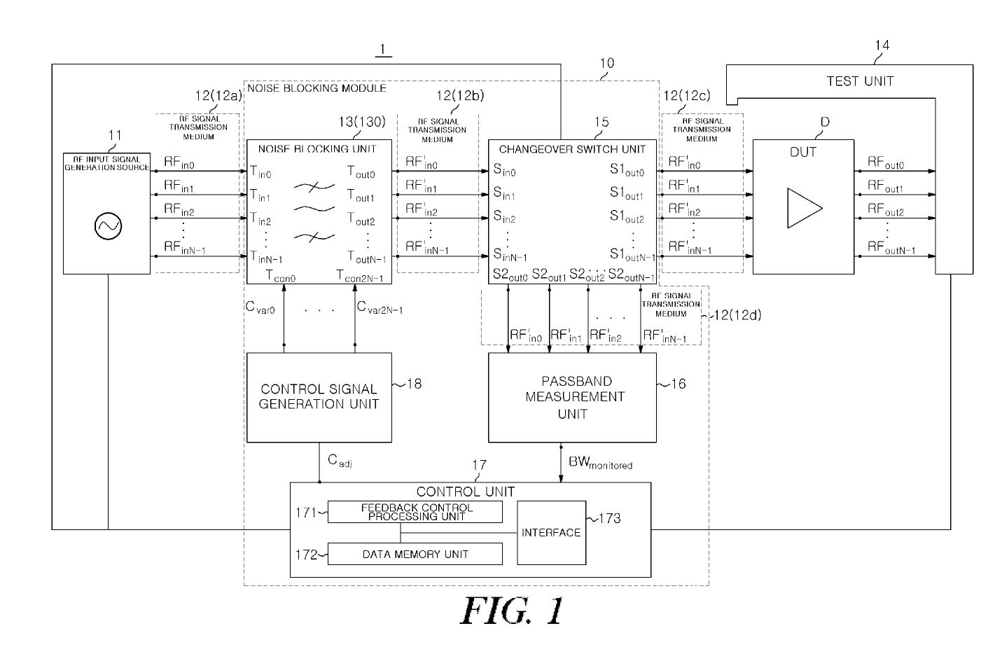

FIG. 1 is a block diagram illustrating configuration of an apparatus for testing an electronic device, in accordance with a representative embodiment. As illustrated in FIG. 1, test apparatus 1 is provided for testing an electronic device configured to process a radio frequency (RF) signal, shown as device under test (DUT) D, such as a single-band or multiband RF power amplifier, for example. The test apparatus 1 includes an RF input signal generation source 11, an RF signal transmission medium 12, a noise blocking unit 13, a changeover switch unit 15, a passband measurement unit 16, a control unit 17, a control signal generation unit 18, and a test unit 14. Certain of the aforementioned elements of the test apparatus 1 are part of a noise blocking module 10. More particularly, the noise blocking module 10 includes a second section 12b and a fourth section 12d of the RF signal transmission medium 12, the noise blocking unit 13, the changeover switch unit 15, the passband measurement unit 16, the control unit 17, and the control signal generation unit 18.

The RF input signal generation source 11 generates one or more predetermined RF input signals RFᵢₙ₀, RFᵢₙ₁, . . . , RF_{inN-1}, and outputs them through one or more output terminals (hereinafter, the one or more predetermined RF input signals RFᵢₙ₀, RFᵢₙ₁, . . . , RF_{inN-1} may be collectively referred to as RF input signals RFᵢₙ for the sake of convenience). In various embodiments, the RF input signal generation source 11 may generate a plurality of (N) RF input signals RFᵢₙ having different electrical characteristics, for example, different bandwidths, and outputs the RF input signals RFᵢₙ through corresponding terminals of a plurality of output terminals. For example, there may be four types of RF input signals (N=4).

The RF signal transmission medium 12 transfers the RF input signals RFᵢₙ from the RF input signal generation source 11 via the noise blocking unit 13 to the passband measurement unit 16 or the DUT D, which is mounted on the test unit 14. The RF signal transmission medium 12 includes a plurality of sections, including for example a first section 12a for connecting the RF input signal generation source 11 and the noise blocking unit 13, a second section 12b for connecting the noise blocking unit 13 and the changeover switch unit 15, a third section 12c for connecting the changeover switch unit 15 and the DUT D, and a fourth section 12d for connecting the changeover switch unit 15 and the passband measurement unit 16. Among the aforementioned sections, the second section 12b and the fourth section 12d are included in the noise blocking module 10, as mention above and as further described below.

Furthermore, in various embodiments, the RF signal transmission medium 12 includes N lines (where N is an integer greater than or equal to 1), e.g., four lines (N=4), for respectively transmitting RF input signals RFᵢₙ₀, RFᵢₙ₁, . . . , RF_{inN-1} having different characteristics, e.g., different bandwidths. In this case, the line or each of the lines has portions that fall within the first, second, third and fourth sections 12a, 12b, 12c and 12d, respectively. The RF signal transmission medium 12 may include an RF cable, and may be implemented using additional parts (not illustrated), such as connectors, adapters and switches, in addition to the RF cable.

The test unit 14 tests the DUT D by analyzing RF output signals RFₒᵤₜ₀, RFₒᵤₜ₁, RFₒᵤₜ₂, . . . , RF_{outN-1} from the DUT D responsive to the RF signals RFᵢₙ₀, RFᵢₙ₁, . . . , RF_{inN-1}. In accordance with an embodiment, the test unit 14 may be configured to mount on the DUT D, and to test the performance of the DUT D for determining whether the DUT D is a good product or a defective product based on RF signals RFₒᵤₜ₀, RFₒᵤₜ₁, RFₒᵤₜ₂, . . . , RF_{outN-1} output from the DUT D and predetermined test criteria. The DUT D may be the RF power amplifier, for example, such as a multiband power amplifier. However, the test apparatus 1 is not limited to testing RF power amplifiers, but may used to test any other types of electronic devices, as long as they are capable of processing RF input signals. In addition, the test unit 14 may be implemented using a handler machine and/or a test jig, for example.

Various elements included in the noise blocking module 10 are described below.

The noise blocking unit 13 prevents noise, infiltrated into the RF input signals through the RF input signal generation source 11 and the first section 12a of the RF signal transmission medium 12, from being received by the DUT D. The noise blocking unit 13 receives the RF input signals RFᵢₙ and outputs corresponding noise blocked RF input signals RF′ᵢₙ₀, RF′ᵢₙ₁, RF′ᵢₙ₂, . . . , RF′_{inN-1} (hereinafter, the one or more noise blocked RF input signals RF′ᵢₙ₀, RF′ᵢₙ₁, RF′ᵢₙ₂, . . . , RF′_{inN-1} may be collectively referred to as noise blocked RF input signals RF′ᵢₙ for the sake of convenience). For this purpose, the noise blocking unit 13 passes only signals in a passband range by filtering out noise propagating along the RF signal transmission medium 12. That is, the noise blocking unit 13 blocks noise having frequencies outside the passband. In various embodiments, the noise blocking unit 13 may physically block or absorb RF noise transferred without passing through the RF signal transmission medium 12 static electricity, electromagnetic waves or the like, for example, transferred along the surface of the noise blocking unit 13. Furthermore, the passband of the noise blocking unit 13 is configured to vary in accordance with the feedback control of the control unit 17.

The noise blocking unit 13 includes RF signal input terminals Tᵢₙ₀, Tᵢₙ₁, Tᵢₙ₂, T_{inN-1}, RF signal output terminals Tₒᵤₜ₀, Tₒᵤₜ₁, Tₒᵤₜ₂, . . . , T_{outN-1}, and control signal input terminals T_{con0}, T_{con1}, T_{con2}, . . . , T_{con2N-1} (hereinafter, RF signal input terminals Tᵢₙ₀, Tᵢₙ₁, Tᵢₙ₂, . . . , T_{inN-1} may be collectively referred to as RF signal input terminals Tᵢₙ, RF signal output terminals Tₒᵤₜ₀, Tₒᵤₜ₁, Tₒᵤₜ₂, . . . , T_{outN-1} may be collectively referred to as RF signal output terminals Tₒᵤₜ, and control signal input terminals T_{con0}, T_{con1}, T_{con2}, . . . , T_{con2N-1} may be collectively referred to as control signal input terminals T_{con}, for the sake of convenience). The noise blocking unit 13 includes one or more noise filters having corresponding passbands that vary with variations in voltages of control signals Cᵥₐᵣ₀, Cᵥₐᵣ₁, Cᵥₐᵣ₂, . . . , C_{var2N-1} received by the noise blocking unit 13 from the control signal generation unit 18 through the control signal input terminals T_{con}, respectively (hereinafter, the control signals Cᵥₐᵣ₀, Cᵥₐᵣ₁, Cᵥₐᵣ₂, . . . , C_{var2N-1} may be collectively referred to as control signals Cᵥₐᵣ, for the sake of convenience).

The RF signal input terminals Tᵢₙ of the noise blocking unit 13 are connected to the output terminals of the RF input signal generation source 11 through the first section 12a of the RF signal transmission medium 12, and the RF signal output terminals Tₒᵤₜ of the noise blocking unit 13 are connected to the input terminals of the changeover switch unit 15 through the second section 12b of the RF signal transmission medium 12. The configuration of the noise blocking unit 13 will be described in greater detail below in connection with a noise blocking module and a noise filter.

The changeover switch unit 15 is configured to switch the flow of the noise blocked RF input signals RF′ᵢₙ (with noise blocking applied thereto), so that the noise blocked RF input signals RF′ᵢₙ are selectively transmitted from the second section 12b of the RF signal transmission medium 12 to the third section 12c or fourth section 12d of the RF signal transmission medium 12. For this purpose, the changeover switch unit 15 includes input terminals Sᵢₙ₀, Sᵢₙ₁, Sᵢₙ₂, . . . , S_{inN-1} connected to the output terminals Tₒᵤₜ of the noise blocking unit 13 through the second section 12b of the RF signal transmission medium 12, first output terminals S1ₒᵤₜ₀, S1ₒᵤₜ₁, S1ₒᵤₜ₂, . . . , S1_{outN-1} connected to the DUT D (e.g., the RF power amplifier) through the third section 12c of the RF signal transmission medium 12, and second output terminals S2ₒᵤₜ₀, S2ₒᵤₜ₁, S2ₒᵤₜ₂, . . . , S2_{outN-1} connected to the input terminals of the passband measurement unit 16 through the fourth section 12d of the RF signal transmission medium 12.

Furthermore, the changeover switch unit 15 may be implemented using a switching circuit in order to switch the above-described flow of the signals. In this case, the switching circuit of the changeover switch unit 15 is configured to allow all the noise blocked RF input signals RF′ᵢₙ (with noise blocking applied thereto) to be transmitted to the third section 12c of the RF signal transmission medium 12, or all the noise blocked RF input signals RF′ᵢₙ to be transmitted to the fourth section 12d of the RF signal transmission medium 12, but not to allow some of the noise blocked RF input signals RF′ᵢₙ to be transmitted to the third section 12c of the RF signal transmission medium 12 and the others of the noise blocked RF input signals RF′ᵢₙ to be transmitted to the fourth section 12d of the RF signal transmission medium 12 at the same time.

The passband measurement unit 16 measures the passband (or bandwidth) of the noise blocking unit 13 based on the bandwidth of the noise blocked RF input signals RF′ᵢₙ, which are output from the noise blocking unit 13, and outputs the passband of the noise blocking unit 13 to the control unit 17 as a passband value BW_{monitored}. Accordingly, it is possible to monitor the passband of the noise blocking unit 13 using the passband measurement unit 16. The input terminals of the passband measurement unit 16 are connected to the output terminals of the noise blocking unit 13 through the changeover switch unit 15 and the fourth section 12d of the RF signal transmission medium. Furthermore, the output terminal of the passband measurement unit 16 is connected through a wired or wireless medium capable of transmitting data to the input terminal of the control unit 17. In various embodiments, the passband measurement unit 16 may be implemented using a vector network analyzer (VNA), for example.

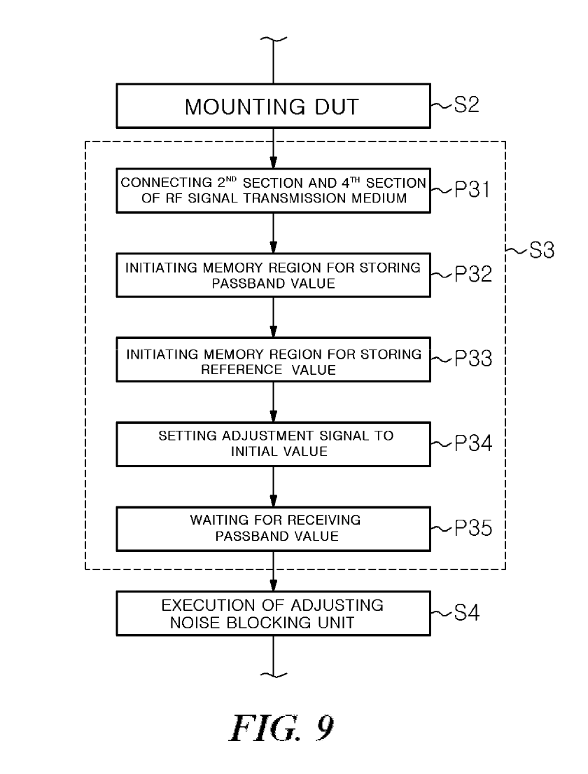

The control unit 17 may control the individual components of the apparatus 1 so that the individual steps of a method for testing the DUT D, e.g., illustrated in FIG. 8, are performed. In particular, the control unit 17 may perform feedback control of the noise blocking unit 13 and the control signal generation unit 18, so that the passband of the noise blocking unit 13 can be maintained at a target value or within a target range, in response to an adjustment signal C_{adj}, determined by the control unit 17, based on the passband value BW_{monitored} of the noise blocking unit 13 from the passband measurement unit 16, and output to the control signal generation unit 18.

The adjustment signal C_{adj} output from the control unit 17 is related to the voltage of the control signal output from the control signal generation unit 18. In an embodiment, the adjustment signal C_{adj} may provide the voltage value of the control signal. In another embodiment, the adjustment signal C_{adj} may provide a variation in the voltage value of the control signal. In still another embodiment, the adjustment signal C_{adj} may provide only an increase, a reduction or maintenance in the voltage value of the control signal.

The control unit 17 includes a feedback control processing unit 171, a data memory unit 172, and an interface 173. The feedback control processing unit 171 is hardware and/or software configured to perform information processing required for feedback control. The data memory unit 172 is a computer readable medium (e.g., hardware) that stores the passband value BW_{monitored} of the passband of the noise blocking unit 13 monitored by the passband measurement unit 16, passbands required for the feedback control, and reference values of adjustment signal C_{adj} and/or variations in the voltages of control signals Cᵥₐᵣ. The interface 173 is hardware and/or software that acts as a medium that exchanges input and output for a user or signals for control of individual components of the apparatus 1 for testing the performance of the DUT D. Furthermore, the control unit 17 is connected over a wired or wireless medium in order to exchange signals with at least some of the components of the apparatus 1 for testing the performance of the DUT D.

The control unit 17 includes one or more processing devices configured to perform the functions of the feedback control processing unit 171, the data memory unit 172 and the interface 173, one or more memories, and one or more peripheral devices, and may be implemented in various forms. For example, in various embodiments, the control unit 17 may be implemented by one or more computer processors, such as a microcontroller unit (MCU), a microprocessing unit (MPU) or a central processing unit (CPU), using software, firmware, hard-wired logic circuits, or combinations thereof. The MCU, for example, may be programmed to operate in accordance with an algorithm for performing the above-described feedback control, memory (e.g., computer readable medium) configured to store data, such as reference values, which are used for the feedback control, and a general-purpose computer configured to perform data communication in order to provide the interface 173 between the user and the MCU. Alternatively, in various embodiments, the memory may be replaced with a memory device inside the MCU or a memory device inside the general-purpose computer. Generally, memory and memory devices (including the data memory unit 172) may include any number, type and combination of random access memory (RAM) and read-only memory (ROM), for example, such as an electrically programmable read-only memory (EPROM), an electrically erasable and programmable read only memory (EEPROM), a universal serial bus (USB) drive, and the like, which are non-transitory (e.g., as compared to transitory propagating signals). In various embodiments, the control unit 17 may be implemented using a dedicated computer specially designed for a predetermined purpose instead of the general-purpose computer. Alternatively, the control unit 17 may be implemented, at least in part, using one or more of processors, memories and/or peripheral devices that constitute the test unit 14.

The control signal generation unit 18 outputs control signals Cᵥₐᵣ to the noise blocking unit 13, where the control signals Cᵥₐᵣ vary in accordance with the adjustment signal C_{adj} output from the control unit 17. The output terminals of the control signal generation unit 18 are connected over a wired or wireless medium in order to exchange signals with the control signal input terminals T., of the noise blocking unit 13. In various embodiments, the control signal generation unit 18 is configured such that the voltages of the control signals Cᵥₐᵣ vary with the value of the adjustment signal C_{adj} output from the control unit 17.

Operation of the apparatus with respect to testing performance of a DUT (e.g., an RF power amplifier) will be described below in conjunction with a method for testing the performance of RF power amplifiers.

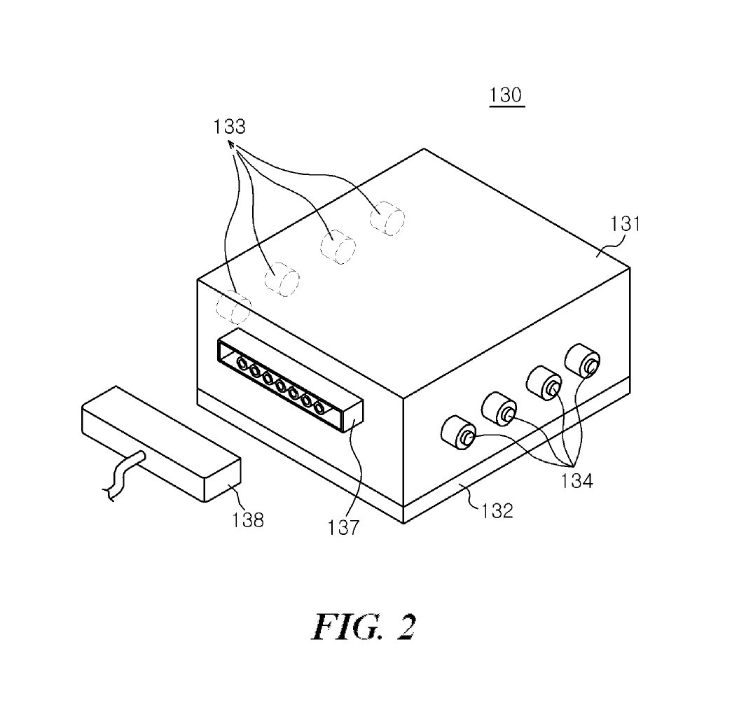

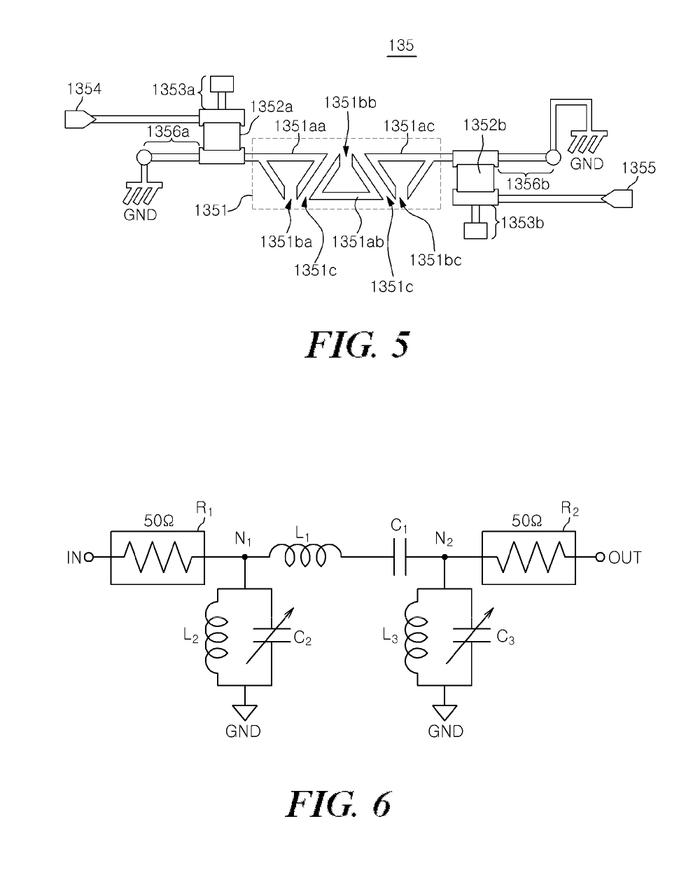

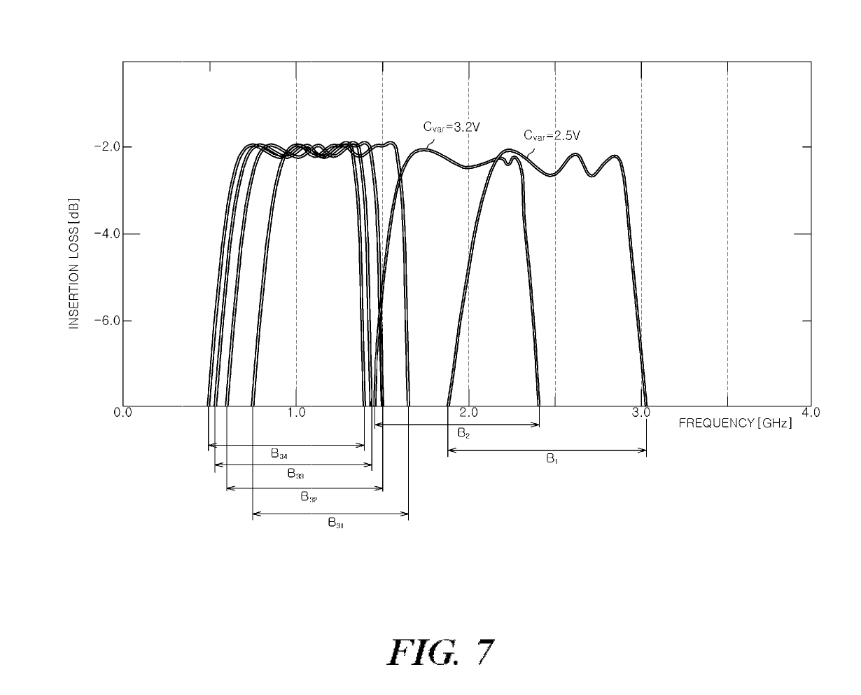

The detailed configuration of the noise blocking unit 13 of the test apparatus 1 for testing the performance of DUT D will now be described. In an embodiment, the noise blocking unit 13 of the test apparatus 1 for testing the performance of the DUT D (e.g., RF power amplifier) illustrated in FIG. 1 may be implemented using embodiments of the noise blocking unit 130 illustrated in FIGS. 2 to 4, or using another mechanism that includes a noise filter 135, as illustrated in FIGS. 5 and 6, but differs from the noise blocking unit 130.

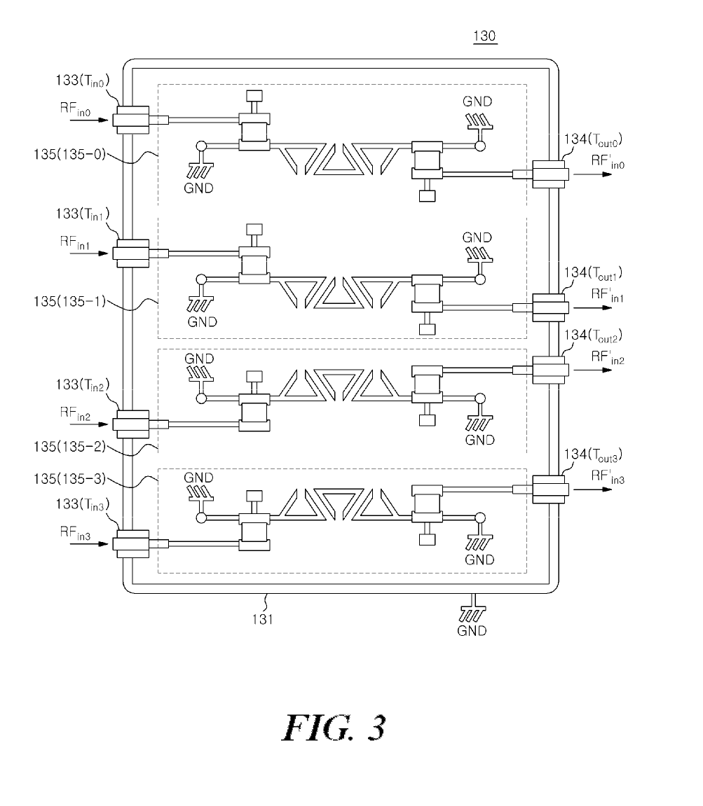

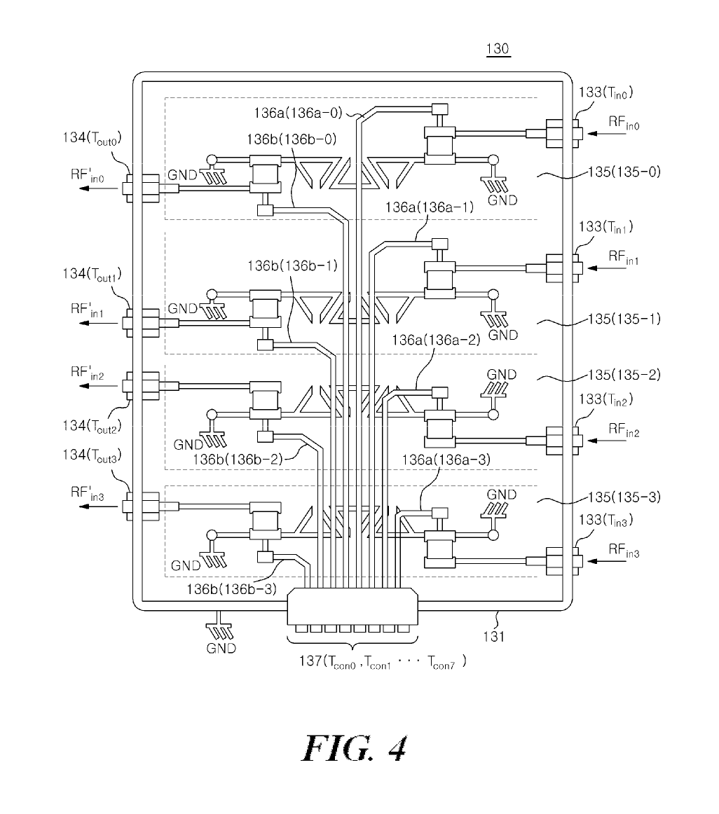

FIG. 2 is a perspective view of noise blocking unit 130, and FIGS. 3 and 4 are top and bottom plan views of the noise blocking unit 130, respectively, according to representative embodiments. As illustrated in FIGS. 2 to 4, the noise blocking unit 130 may include a housing 131, RF signal input terminals 133, RF signal output terminals 134, control signal input terminals 137, control lines 136a and 136b, and one or more noise filters 135.

The housing 131 accommodates the other components of the noise blocking unit 130, and exposes some of the RF signal input terminals 133, the RF signal output terminals 134 and the control signal input terminals 137 to the outside. In various embodiments, the housing 131 is made of a material that can block or absorb noise input from the outside. For example, the material of the housing 131 may converts static electricity or radio waves into heat and prevent static electricity or radio waves input from the outside and flowing through the surface of the housing 131 from flowing into the housing 131 by absorbing static electricity or radio waves. In this case, the noise blocking unit 130 has the dual blocking function of blocking both noise already infiltrated into the RF signal transmission medium using the noise filters 135 and noise infiltrated along the surface of the noise blocking unit 130. The surface of the housing 131 is grounded.

In various embodiments, the noise blocking unit 130 may further include a mounting part 132. The mounting part 132 is configured to enable the noise blocking unit 130 to be easily and selectively attached and detached in and from a space where the test apparatus for testing the performance of RF power amplifiers, for example, is installed and to maintain a stable attached state. In various embodiments, the mounting part 132 includes a magnetic panel. With the mounting part 132, installation and management of the test apparatus is quick and convenient.

The RF signal input terminals 133 correspond to the RF signal input terminals Tᵢₙ of the noise blocking unit 13 illustrated in FIG. 1. RF signals are input to the noise blocking unit 130 through the RF signal input terminals 133. The RF signal output terminals 134 correspond to the RF signal output terminals Tₒᵤₜ of the noise blocking unit 13 illustrated in FIG. 1. RF signals with noise blocking applied thereto are output from the noise blocking unit 130 through the RF signal output terminals 134.

The control signal input terminals 137 correspond to the control signal input terminals T_{con} of the noise blocking unit 13 illustrated in FIG. 1. Control signals that are used to control the noise filters 135 are input to the noise blocking unit 130 through the control signal input terminals 137. In various embodiments, the control signal input terminals 137 may be implemented based on a standardized system management bus (SMB), in which case the noise blocking unit 130 is allowed to connect to a control signal generator, e.g., the control signal generation unit 18 of the apparatus 1 as illustrated in FIG. 1, via a standardized cable 138 illustrated in FIG. 2, and thereby compatibility with other components of the test apparatus is improved and the installation and management of the test apparatus for testing the performance of RF power amplifiers is facilitated.

The control lines 136a, 136b illustrated in FIG. 4 electrically connect the control signal input terminals 137 and the noise filters 135. Each of the noise filters 135 filters components, which do not satisfy predetermined criteria and are treated as noise, out of RF signals received through the RF signal input terminals 133, and outputs only components satisfying the predetermined criteria.

The noise blocking unit 130 may include one or more of the noise filters 135 depending on a DUT. In the depicted embodiment, the noise blocking unit 130 includes four noise filters, noise filters 135-0, 135-1, 135-2 and 135-3, each of which has basically similar configurations, and may be used by the test apparatus for testing the multiband power amplifier as the DUT. Each of the noise filters 135-0 to 135-3 includes an RF signal input terminal, an RF signal output terminal, and a control signal input terminal. Of course, more or fewer noise filters 135 may be included, without departing from the scope of the present teachings.

An illustrative configuration of a noise filter 135 in accordance with an embodiment will now be further described. FIG. 5 is a plan view of a noise filter implemented using a microstrip structure, in accordance with a representative embodiment. In accordance with this embodiment, the noise filter 135 is a band-pass filter, and includes a filter resonator 1351, one or more variable capacitors 1352a and 1352b, via pads 1353a and 1353b, an RF signal input terminal 1354, and an RF signal output terminal 1355. Further, in designing the noise filter 135, impedance matching is performed for electrical connection between the noise filter 135 and an exterior electrical element.

The filter resonator 1351 is connected between the variable capacitors 1352a and 1352b, and has a microstrip structure in which a plurality of triangles is arranged. More specifically, the microstrip structure includes a plurality of microstrip line portions 1351aa, 1351ab and 1351ac bent to form triangular shapes. Gaps 1351ba, 1351bb and 1351bc are formed between both ends of the triangular microstrip line portions 1351aa, 1351ab and 1351ac. The triangular microstrip line portions 1351aa, 1351ab and 1351ac are arranged in a row, such that every other triangular microstrip line portion 1351aa, 1351ab and 1351ac is inverted, and adjacent triangular microstrip line portions 1351aa, 1351ab and 1351ac are separated by space 1351c.

The noise filter 135 of FIG. 5 includes two variable capacitors 1352a and 1352b. A first side of the variable capacitor 1352a is connected to ground GND and the filter resonator 1351, and a second side of the variable capacitor 1352a is connected to the RF signal input terminal 1354, while a first side of the variable capacitor 1352b is connected to ground GND and the filter resonator 1351, and a second side of the variable capacitor 1352b is connected to the RF signal output terminal 1355. The other end of each of the variable capacitors 1352a and 1352b is connected to a via pad 1353a or 1353b, through which it is connected to the control line 136a or 136b, respectively. In various embodiments, the variable capacitors 1352a and 1352b may be varactor diodes, for example. The capacitance of each of the variable capacitors 1352a and 1352b varies with the voltage of a control signal input through each of the control lines 136a and 136b connected to the corresponding variable capacitor 1352a or 1352b.

FIG. 6 is a circuit diagram illustrating an equivalent circuit of the noise filter 135 of FIG. 5, according to a representative embodiment. As illustrated in FIG. 6, the equivalent circuit of the noise filter 135 includes a first inductor L₁ and a first capacitor C₁ corresponding to the filter resonator 1351, a second capacitor C₂ and a third capacitor C₃ respectively corresponding to the two variable capacitors 1352a and 1352b, a first resistor R₁ and a second resistor R₂ performing impedance matching, and an input terminal IN and an output terminal OUT. Furthermore, the equivalent circuit further includes a second inductor L₂ and a third inductor L₃ corresponding to inductance components of the microstrip lines (1356a and 1356b of FIG. 5) that connect the first sides of the variable capacitors 1352a and 1352b to ground GND.

Meanwhile, a first node N₁ and a second node N₂ are defined for convenience of description of the connection relationship between the above components. The first end of the first inductor L₁ is connected to the first node N₁, and the second end of the first inductor L₁ is connected to the first end of the first capacitor C₁. Furthermore, the second end of the first capacitor C₁ is connected to the second node N₂.

The second capacitor C₂ is connected to the second inductor L₂ in parallel. The first end of the second inductor L₂ and the first end of the second capacitor C₂ are connected to the first node N₁, and the second end of the second inductor L₂ and the second end of the second capacitor C₂ are connected to a ground GND. In the same manner, the third capacitor C₃ is connected to the third inductor L₃ in parallel. The first end of the third inductor L₃ and the first end of the third capacitor C₃ are connected to the second node N₂, and the second end of the third inductor L₃ and the second end of the third capacitor C₃ are connected to ground GND.

The first end of the first resistor R₁ is connected to an input terminal IN, and the second end of the first resistor R₁ is connected to the first node N₁. In the same manner, the first end of the second resistor R₂ is connected to the second node N₂, and the second end of the second resistor R₂ is connected to an output terminal OUT. The first resistor R₁ and the second resistor R₂ have a resistance value predetermined for impedance matching, for example, 50 ohms.

As described in conjunction with FIGS. 5 and 6, the noise filter 135 is implemented using a variable capacitor, so that the passband of the noise filter 135 can vary in accordance with a control signal. That is, the passband of the noise filter 135 may be controlled by varying the capacitance of the variable capacitor by adjusting the voltage of a control signal.

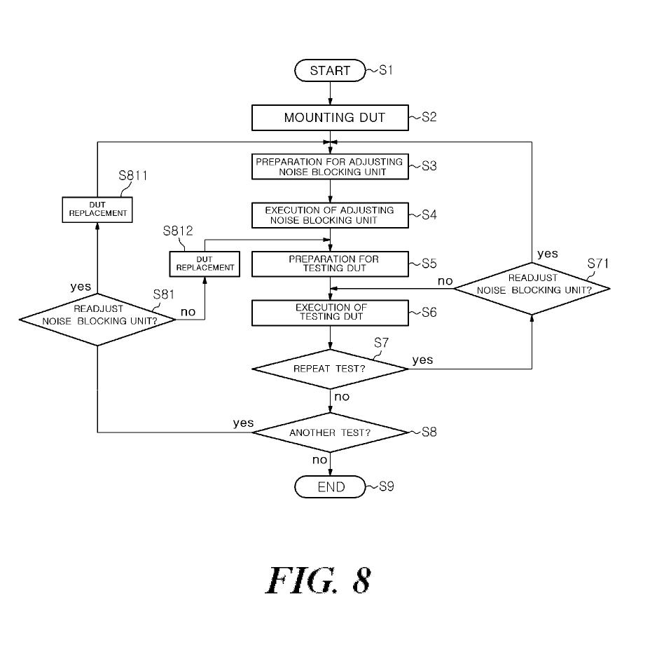

FIG. 7 depicts experimental results obtained by observing variations in the passband of the noise filter 135 of FIG. 5 attributable to variations in a voltage value of a control signal input to the noise filter 135, in accordance with a representative embodiment. As illustrated in FIG. 7, as the voltage of the control signal increases from 2.5 V to 3.2 V, for example, the passband shifts from bandwidth B₁ from about 1.9 GHz to about 3.0, GHz to bandwidth B₂ from about 1.4 GHz to about 2.4 GHz. Furthermore, as the control signal changes in small increments, the passband also shifts in small increments. This is illustrated by representative passbands B₃₁, B₃₂, B₃₃, and B₃₄ in FIG. 7. From these experimental results, it can be seen that as the voltage value of the control signal increases, the passband is shifted from a higher frequency band to a lower frequency band, in an amount generally corresponding to the amount the voltage value increases. The passband can thus be controlled in a detailed manner.

Although the above-described noise filter has been assumed to be a band-pass filter, in other embodiments, the noise filter may be implemented as a low-pass filter, a high-pass filter, another filter and/or an element capable of passing only a predetermined frequency component of an input signal therethrough, without departing from the scope of the present teachings. Furthermore, although the above-described noise filter is shown as implemented using two variable capacitors, in other embodiments, the noise filter may be implemented using a single variable capacitor, or using three or more variable capacitors, without departing from the scope of the present teachings.

Meanwhile, since the inductors and the capacitors that constitute the noise filter are components that may vary passband, it may be possible in various embodiments to configure the noise filter so that the bandwidth of the noise filter is adjusted by varying the inductance of the inductors. However, spatial efficiency may be deteriorated by increasing the size of the inductors to achieve desired inductance, since the inductance value of an inductor is determined by the number of turns of a corresponding coil. Furthermore, there may be cases in which loss of power in the inductors is indispensible to achieve desired inductance, since the number of turns of the coil of an inductor is a Q factor defined as a value obtained by dividing the resistance value of the inductor by the inductance value of the inductor, that is, a factor that determines power that is lost in the inductor. To perform the feedback control of the passband of the noise blocking unit, it is necessary to frequently monitor the passband. Since there are cases where, in monitoring the bandwidth, monitoring variations in current attributable to variations in inductance is easier than monitoring variations in voltage attributable to variations in capacitance, this should be taken into consideration when a configuration in which inductance of inductors can be varied is selected.

In accordance with embodiments of the noise blocking device and/or the noise filter, control may be performed by adjusting the voltage of a control signal input to the noise filter, so that the passband of the noise filter falls within a desired range. Accordingly, when the above-described noise blocking unit and/or noise filter is used in the noise blocking module of the test apparatus for testing the performance of RF power amplifiers, a problem resulting from the shift of passband can be overcome by adjusting the passband of the noise blocking unit to a desired value, regardless of factors related to the environment in which the test apparatus is installed to test performance of the DUT.

The operation of the test apparatus for testing the electronic device and a method of testing the electronic device using the test apparatus and/or the noise blocking device will now be described. In accordance with an embodiment, various steps of the method of testing the electronic device are performed by operating the test apparatus including the noise blocking device. Accordingly, the aforementioned method and the operation of the test apparatus will be described together.

FIG. 8 is a flowchart illustrating operation of the test apparatus for testing performance of DUTs (e.g., RF power amplifiers), in accordance with a representative embodiment. The flowchart is in the form of an operational algorithm of the control unit of the test apparatus.

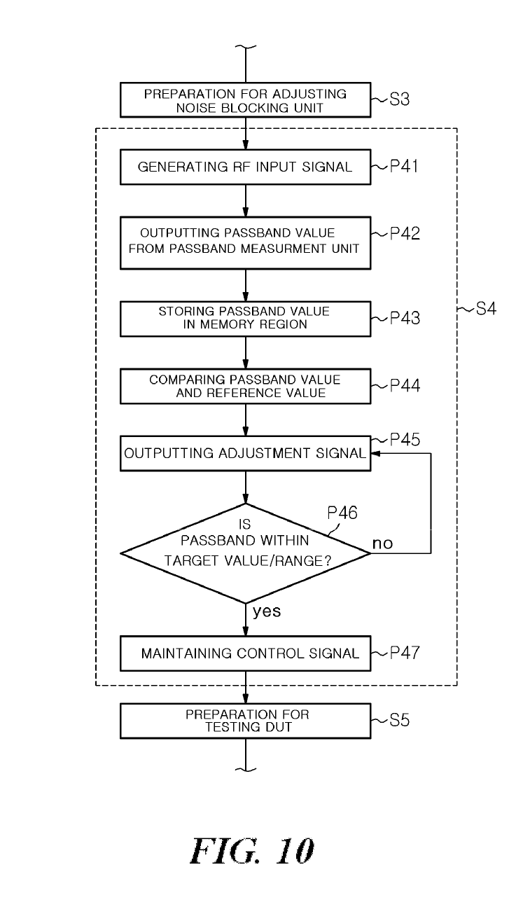

The operation of the test apparatus 1 for testing the performance of RF power amplifiers, for example, may start in response to occurrence of a predetermined event, such as the input of a start signal of a user via the interface 173 of the control unit 17 (start step S1). The test apparatus 1 allows the test unit 14 to be mounted on a DUT, e.g., loaded with an RF power amplifier (mounting DUT step S2). An environment required for feedback control that will be performed to adjust the passband of the noise blocking unit 13 is set (preparation for adjusting noise blocking unit step S3). For example, as illustrated in FIG. 9, in the preparation for adjusting noise blocking unit step S3, the changeover switch unit 15 is set so that the RF input signal is transmitted to the passband measurement unit 16. That is, the second section 12b of the RF signal transmission medium 12 is electrically connected to the fourth section 12d of the

RF signal transmission medium 12 (substep P31 in FIG. 9). Furthermore, the control unit 17 initializes a data region of the data memory unit 172, in which the passband value of the noise blocking unit 13, received from the passband measurement unit 16, will be stored (substep P32), and prepares and initiates a data region of the data memory unit 172 in which reference values have been stored (substep P33). Furthermore, an adjustment signal from the control unit 17 is set to a predetermined initial value, so that the voltage of control signal Cᵥₐᵣ that will be received by the control signal input terminal of the noise blocking unit 13 becomes a predetermined initial value (substep P34). Once the above setting has been completed, the control unit 17 enters a waiting state to wait for a passband value BW_{monitored} output from the passband measurement unit 16 to be recorded in the data memory unit 172 (substep P35).

Moreover, although the mounting DUT step S2 has been described as being performed prior to the preparation for adjusting noise blocking unit step S3, this is not essential. In various embodiments, if a test on the DUT has not been carried out, the mounting DUT step S2 may be performed concurrently with or after the preparation for adjusting noise blocking unit step S3. In the same manner, the above-described substeps P31, P32, P33 and P34 of the preparation for adjusting noise blocking unit preparation step S3 are not necessarily performed in the order from substep P31 to substep P34, and may be performed in other orders in various embodiments, without departing from the scope of the present teachings.

After the settings of the environment required for feedback control have been completed, feedback control is performed to adjust the passband of the noise blocking unit 13 to a predetermined value (execution of adjusting noise blocking unit step S4). For example, as illustrated in FIG. 10, in the execution of adjusting noise blocking unit step S4, an RF input signal is generated by operating the RF input signal generation source, and then the RF input signal sequentially passes through the first section 12a of the RF signal transmission medium 12, the noise blocking unit 13, the changeover switch unit 15 and the third section 12c of the RF signal transmission medium 12, and is finally received by the passband measurement unit 16 (substep P41). The passband measurement unit 16 obtains the passband value of the passband of the noise blocking unit 13 by analyzing the bandwidth of the received RF input signal (substep P42). The obtained passband value is received by the control unit 17 and then recorded in the data memory unit 172 (substep P43). The feedback control processing unit 171 of the control unit 17 compares the recorded passband value with predetermined passband reference values (substep P44), and outputs an adjustment signal based on an adjustment signal reference value corresponding to the results of the comparison (substep P45).

Thereafter, the feedback control processing unit 171 determines whether the passband of the noise blocking unit 13 is the same as a target value and/or falls within a predetermined range (substep P46). If so, the method/operation proceeds to maintain the state of the current control signal (substep P47). If not, the method/operation returns to substep P45 and then repeatedly updates the adjustment signal.

Although substep P46 may be implemented by performing substeps P41 to P44, this is not invariably the case. In alternative embodiments, the various substeps may simply be implemented by determining whether the sizes of the components of the RF input signal corresponding to upper and lower frequency limits in the predetermined passband reference values are larger than a predetermined reference value (for example, −2.5 dB).

Once the adjustment of the passband of the noise blocking unit 13 has been completed, the control unit 17 tests the performance of the RF power amplifier (preparation for testing DUT step S5). At preparation for testing DUT step S5, the changeover switch unit 15 connects the second section 12b of the RF signal transmission medium 12 and the third section 12c of the RF signal transmission medium 12.

Once the preparation for testing DUT step S5 has been completed, a test on the DUT D is carried out (execution of testing DUT step S6). Upon execution of testing DUT step S6, the test unit 14 determines whether an amplified RF signal from the RF power amplifier (i.e., the

DUT in the present example) satisfies the predetermined criteria. If the amplified RF signal satisfies the predetermined criteria, the test unit 14 determines that the DUT is a good product. If not, the test unit 14 determines that the DUT is a defective product.

Depending on the real-time manipulation or previous settings of the user, the determination may be repeated at step S7. Depending on the real-time manipulation or previous settings of the user, the adjustment of the passband of the noise blocking unit 13 may be repeated whenever a test on a single DUT is repeated at step S71, or may be repeated whenever a test on another DUT is repeated (see step S8) at step S81. The number of times the passband of the noise blocking unit 13 is adjusted may be determined depending on the real-time manipulation or previous settings of the user. It will be apparent that one or more tests on one or more DUTs may be performed without readjustment. If the test on the DUT has been completed and there is no DUT to be tested, the test is terminated at step S9.

In accordance with the above-described apparatus and method for testing the performance of DUTs, such as RF power amplifiers, the value of the passband of the noise blocking unit is automatically stabilized into a desired value within a few seconds by performing the feedback control of the passband of the noise blocking unit.

Thus, generally, an apparatus and method for testing an electronic device, configured to process an RF signal, employ a noise blocking module, situated between an RF input signal generation source and a DUT. The noise blocking module includes a noise blocking unit having an adjustable passband for passing the RF signal and blocking noise, and a control unit configured to perform feedback control on the passband, to ensure accuracy of test results even in an environment, such as a manufacturing environment, crowded with noise.

Accordingly, it is not necessary to spend time and expense in checking the state of the passband of the noise blocking unit and repairing/replacing the test apparatus for testing the performance of RF power amplifiers if there is a problem, or in checking/managing the surrounding environment of the test apparatus for testing the performance of RF power amplifiers.

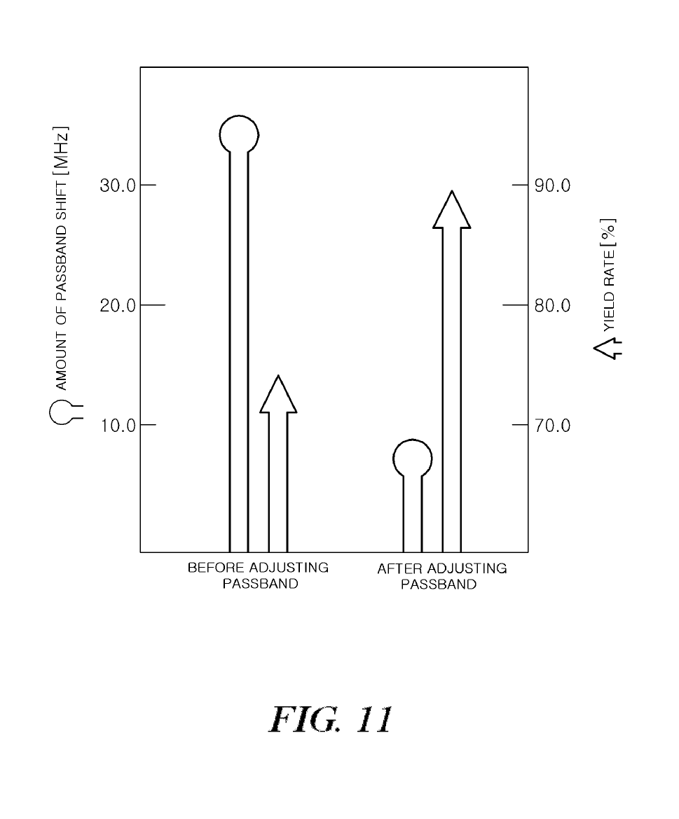

Furthermore, in accordance with the above-described apparatus and method for testing the performance of DUTs, such as RF power amplifiers, test accuracy can be improved and the yield of the DUTs can be increased. FIG. 11 illustrates experimental results that were obtained by comparing passband shifts and yields before and after feedback control of the passband of the noise blocking unit in accordance with the above-described embodiments for testing performance of RF power amplifiers. As illustrated in FIG. 11, by performing feedback control of the passband of the noise blocking unit, the shift of the passband of the noise blocking unit was reduced from about 35 MHz to about 10 MHz, and the yield of the RF power amplifiers as

DUTs was increased from about 75% to about 90%.

While the invention has been shown and described with respect to illustrative embodiments, it will be understood by those skilled in the art that various changes and modifications may be made without departing from the spirit and scope of the invention as defined in the following claims. Further, the various materials, structures and parameters are included by way of example only and not in any limiting sense. In view of this disclosure, those skilled in the art can implement the present teachings in determining their own applications and needed materials and equipment to implement these applications, while remaining within the scope of the appended claims.

What is claimed is:

1. An apparatus for testing an electronic device in response to a radio frequency (RF) input signal, the apparatus comprising:
an RF input signal generation source configured to generate the RF input signal;
a noise blocking unit having a passband for passing the RF input signal and blocking noise to provide a noise blocked RF input signal;
an RF signal transmission medium for transmitting the noise blocked RF input signal to the electronic device;
a passband measurement unit configured to measure the passband of the noise blocking unit based on the noise blocked RF input signal and output a passband value; and
a control unit configured to perform feedback control of the passband by varying a control signal output to the noise blocking unit based on the passband value, so that the passband falls within a target range.

2. The apparatus of claim 1, wherein the noise blocking unit comprises one or more noise filters configured to block noise having a frequency outside the passband.

3. The apparatus of claim 2, wherein the one or more noise filters are band-pass filters.

4. The apparatus of claim 2, wherein each of the one or more noise filters comprises one or more variable capacitors, and
wherein each of the one or more variable capacitors has capacitance that varies with a voltage of the control signal.

5. The apparatus of claim 4, further comprising:
a control signal generation unit configured to receive an adjustment signal from the control unit and to determine the voltage of the control signal based on the adjustment signal.

6. The apparatus of claim 1, wherein the control unit comprises a microcontroller unit (MCU).

7. A noise blocking module, comprising:
a noise blocking unit having a passband for passing a radio frequency (RF) signal and blocking noise;
an RF signal transmission medium for transmitting the RF signal via the noise blocking unit;
a passband measurement unit configured to measure the passband and output a passband value; and
a control unit configured to perform a feedback control of the passband by varying a control signal provided to the noise blocking unit based on the passband value, so that the passband falls within a target range.

8. The noise blocking module of claim 7, wherein the noise blocking unit includes at least one noise filter configured to block noise having frequencies outside the passband.

9. The noise blocking module of claim 8, wherein the at least one noise filter comprises a band-pass filter.

10. The noise blocking module of claim 8, wherein the at least one noise filter includes at least one variable capacitor having a capacitance that varies with a voltage of the control signal.

11. The noise blocking module of claim 10, further comprising:
a control signal generation unit configured to receive an adjustment signal from the control unit and determine the voltage of the control signal based on the adjustment signal.

12. The noise blocking module of claim 7, wherein the control unit comprises a microcontroller unit (MCU).

13. The noise blocking module of claim 1, further comprising:
a housing containing at least the noise blocking unit, and formed of a material that blocks or absorbs noise from the outside.

14. A method for testing an electronic device configured to process a radio frequency (RF) signal, the method comprising:
passing the RF signal and blocking noise with a passband of a noise blocking device;
measuring the passband to obtain a passband value;
performing feedback control of the passband by varying a control signal provided to the noise blocking device based on the passband value, so that the passband falls within a target range;
transmitting the RF signal to the electronic device through the noise blocking device having the passband that falls within the target range; and
analyzing an output from the electric device,
wherein the feedback control of the passband is performed using a control device having a processor and a memory.

15. The method of claim 14, wherein the noise blocking device comprises one or more noise filters configured to block noise having frequencies outside the passband.

16. The method of claim 15, wherein the noise filters are band-pass filters.

17. The method of claim 15, wherein each of the noise filters has one or more variable capacitors, and
wherein each of the variable capacitors has capacitance which varies with a voltage of the control signal.

18. The method of claim 17, wherein performing the feedback control of the passband includes receiving an adjustment signal from the control device and determining the voltage of the control signal based on the adjustment signal.

19. The method of claim 15, wherein the control unit is a microcontroller unit (MCU).

20. The method of claim 14, wherein the electronic device is an RF power amplifier.
